(19) United States
(12) Patent Application Publication
(10) Pub. No.: US 2025/0224998 A1
(43) Pub. Date: Jul. 10, 2025

(54) ZONE ASSIGNMENT FOR HOSTS IN DISTRIBUTED COMPUTING

(71) Applicant: International Business Machines Corporation, Armonk, NY (US)

(72) Inventors: Jacob Garcowski, Raleigh, NC (US); Nathan K. Fritze, Durham, NC (US); Akshay J. D'Souza, Apex, NC (US); Scott Carrier, New Hill, NC (US)

(21) Appl. No.: 18/404,025

(22) Filed: Jan. 4, 2024

(51) Int. Cl. G06F 9/50

(52) U.S. Cl. CPC G06F 9/5083; G06F 9/5072

(57) ABSTRACT

Assigning hosts to zones in a distributed computing environment is provided. A latency metric is determined for each of a plurality of hosts with respect to each other of the plurality of hosts. A first set of hosts, from the plurality of hosts, are clustered into zones based on the latency metrics.

### BACKGROUND

The present disclosure relates to distributed computing, and more specifically, to managing hosts in a distributed computing environment.

In distributed computing environments, hosts may be assigned to zones based on their location. Assigning hosts that are close together into zones can provide benefits such as high availability through redundancy across zones and improved latency for microservices within a zone.

### SUMMARY

According to embodiments of the present disclosure, a computer-implemented method for assigning hosts to zones in a distributed computing environment is provided. The method includes determining a latency metric for each of a plurality of hosts with respect to each other of the plurality of hosts. The method further includes clustering a first set of hosts, from the plurality of hosts, into zones based on the latency metrics.

According to further embodiments of the present disclosure, a system and a computer program product for performing the method are provided.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts an example computing environment according to embodiments of the present disclosure.

FIG. 2 depicts an example host zone assignment module, according to embodiments.

FIG. 3 depicts a block diagram of an example distributed computing environment, according to embodiments.

FIG. 4 depicts a flow diagram of an example method for assigning hosts to zones in a distributed computing environment, according to embodiments.

FIG. 5 depicts an example method for assigning hosts to zones, according to embodiments.

FIG. 6 depicts a flow diagram of a second example method for assigning hosts to zones, according to embodiments.

FIG. 7 depicts an example distance matrix, according to embodiments.

FIG. 8 depicts a flow diagram of an example method for assigning additional hosts to zones when hosts have been previously assigned to zones, according to embodiments.

FIGS. 9A-9E depict an illustrative diagram of an example assignment of hosts to zones, according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to assigning hosts to zones in a distributed computing environment, and more particular aspects relate to automated assigning of hosts to zones based on latency between hosts. While the present disclosure is not necessarily limited to such applications, various aspects of the disclosure may be appreciated through a discussion of various examples using this context.

Host zone assignment is often performed through manual labeling of nodes or automatic scheduling via an algorithm such as round robin. In the complex world of cloud, hybrid cloud, and software defined networking (SDN), hosts on the same subnet might not be collocated within the same datacenter or even within the same city. Similarly, hosts on different subnets might actually exist in the same rack or even on the same hypervisor. It is possible that a user might not even know where their hosts are physically located.

By using latency between hosts as a stand-in for physical distance, we can look beyond the software defined network to approximate the actual distances between hosts. Latency may be a better approximation for distance than network hops, because the length of any given hop cannot be determined without latency information.

Embodiments of the present disclosure provide a method, system, and computer program product for automated assignment of hosts based on inter-host latency.

As used herein, a host may be a compute node that has been attached for use in a distributed computing environment. A compute node may be any suitable computing device, such as a physical or virtual machine. The distributed computing environment provider may specify certain required characteristics of a node to be used as a host. For example, a host may be required to run a particular operating system and/or have particular computing capabilities.

The distributed computing environment may be any computing environment with distributed hosts that process workloads. In some embodiments, the distributed computing environment is a distributed cloud computing environment. An example distributed cloud offering is IBM Cloud Satellite provided by IBM.

In some embodiments, a user may attach a collection of hosts (e.g., virtual machines) to a distributed computing environment provider for use as their distributed computing infrastructure. Hosts may be attached in bulk with some preliminary bootstrapping software installed, such as a listener service that may be employed to trigger cross-host latency metric computations.

After successfully attaching hosts, the distributed computing system provider may initiate a request to the listener service on each host along with a collection of internet protocol (IP) addresses with which to perform cross-hots latency computations. As each host completes the computations, they may communicate their latency metrics to the distributed computing system provider for analysis.

Once the latency metrics have been received by the distributed computing system provider, the provider may assign the hosts to zones based on the latency metrics. The hosts may be clustered with an appropriate algorithm that may optimize for balanced zones, latency regardless of whether the zones are balanced, etc.

In some embodiments, the distributed computing system provider may filter hosts that fail to meet designated latency requirements. These filtered hosts may not be assigned to a zone. In some embodiments, hosts may be given a label based on having high latency metrics. This allows for the distributed system to use the labeled hosts for specialized workloads that can tolerate higher latency metrics.

After hosts have been assigned to zones, additional hosts added at a later time may be assigned to zones in various ways depending on, for example, user preference, number of additional hosts compared to the number of existing hosts, and whether the additional hosts are deemed to be outliers (e.g., with respect to latency) from the existing zones and hosts. For example, all hosts (including those that were previously assigned) may be reassigned to zones as if they were not previously assigned. Alternatively, the additional hosts may be assigned to the existing zones based on mean latency to the zones.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as host zone assignment module 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

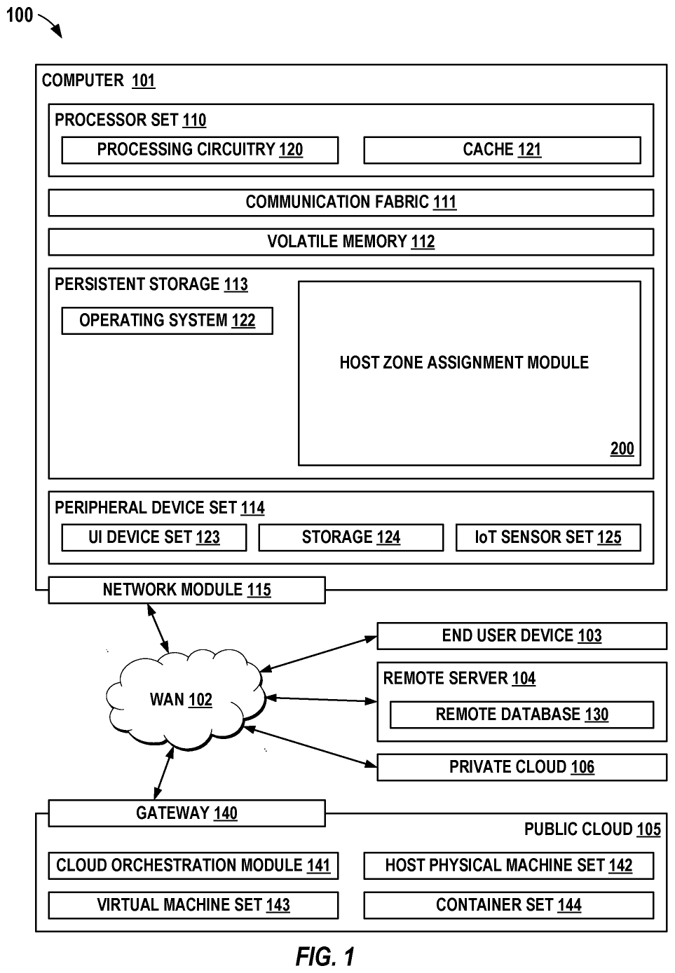

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

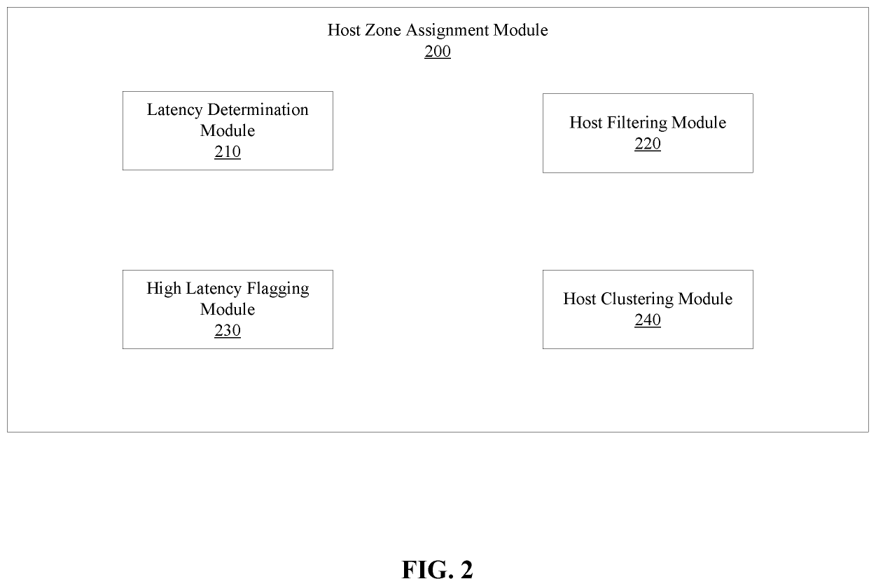

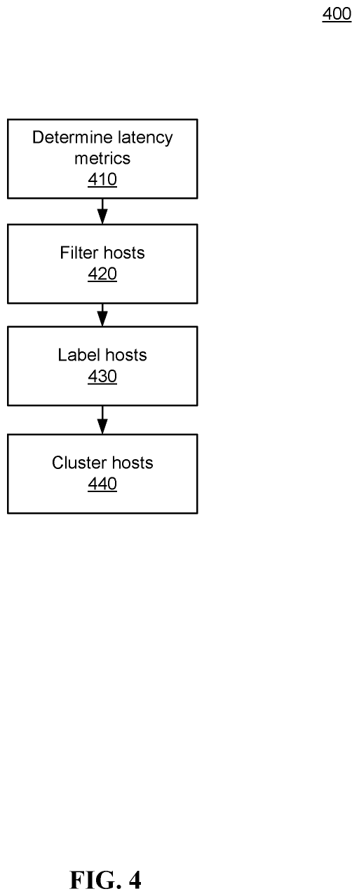

Referring now to FIG. 2, an example host zone assignment module 200 is depicted, according to embodiments. Host zone assignment module 200 includes latency determination module 210, host filtering module 220, host latency flagging module 230, and host clustering module 240. Host zone assignment module 200 may be configured to perform method 400 described in reference to FIG. 4. Latency determination module 210 may be configured to perform operation 410 described in reference to FIG. 4. Host filtering module 220 may be configured to perform operation 420 described in reference to FIG. 4. Host latency flagging module 230 may be configured to perform operation 430 described in reference to FIG. 4. Host clustering module 240 may be configured to perform operation 440 described in reference to FIG. 4.

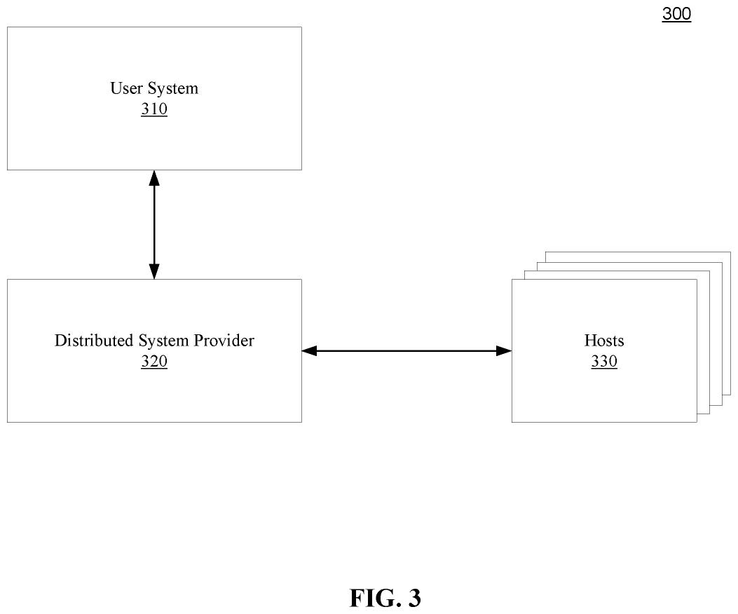

Referring now to FIG. 3, a block diagram of an example distributed computing environment 300 is depicted, according to embodiments. Distributed computing environment 300 includes user system 310, distributed system provider 320, and hosts 330. User system 310 may be any computing device that can be controlled by a user. For example, user system 310 may be end user device 103 described in reference to FIG. 1. Distributed system provider 320 may any suitable computing system for managing a distributed computing system. For example, distributed system provider 320 may be computer 101 described in reference to FIG. 1. Hosts 330 may be any suitable compute nodes that may be used as a host in a distributed computing system.

User system 310 may be configured to communicate with distributed system provider 320 to set up a distributed computing environment. User system 310 may communicate with distributed system provider 320 to attach hosts 330 for use in the distributed computing system. Although user system 310 is depicted in FIG. 3, in some embodiments, a user may be able to directly interact with distributed system provider 320 such that a separate user system is not required.

Referring now to FIG. 4, a flow diagram of an example method 400 for assigning hosts to zones in a distributed computing environment is depicted, according to embodiments. Method 400 may be performed by a distributed computing system provider that manages a distributed computing environment.

At operation 410, a latency metric is determined for each of host with respect to each other host. The hosts may be computing nodes that have been attached to the distributed computing system for use as a host. The distributed computing system provider may instruct each host to compute the latency metric with respect to each other host and provide the results back to the distributed computing system provider. In some embodiments, when a node is attached to a distributed computing system to become a host, preliminary bootstrapping software, such as a listening service, may be installed on the node to allow the node to serve as a host in the distributed computing environment. The distributed computing system provider may communicate with the hosts via the listening service. Any suitable latency metric may be used.

At operation 420, hosts may be filtered based on the determined latency metrics. In some embodiments, the distributed computing system provider may designate one or more latency requirements for hosts. The latency requirements may include a maximum latency between hosts. For example, the distributed computing system provider may require that hosts have a latency within 100 ms with respect to at least one other host.

At operation 430, hosts may be labeled based on the determined latency metrics. In some embodiments, hosts may be labeled to indicate higher latency metrics in response to exceeding one or more latency metric thresholds. Hosts that are labeled may be used for specialized workloads that can tolerate higher latency metrics. In some embodiments, operation 430 is only performed on hosts that were not filtered out in operation 420.

While operations 420 and 430 are depicted in FIG. 4, in some embodiments, one or both may not be performed. For example, in some embodiments, operation 420 is performed and operation 430 is not performed. In other embodiments, operation 430 is performed and operation 420 is not performed. In other embodiments, operation 420 and operation 430 are both not performed such that operation 440 follows operation 410.

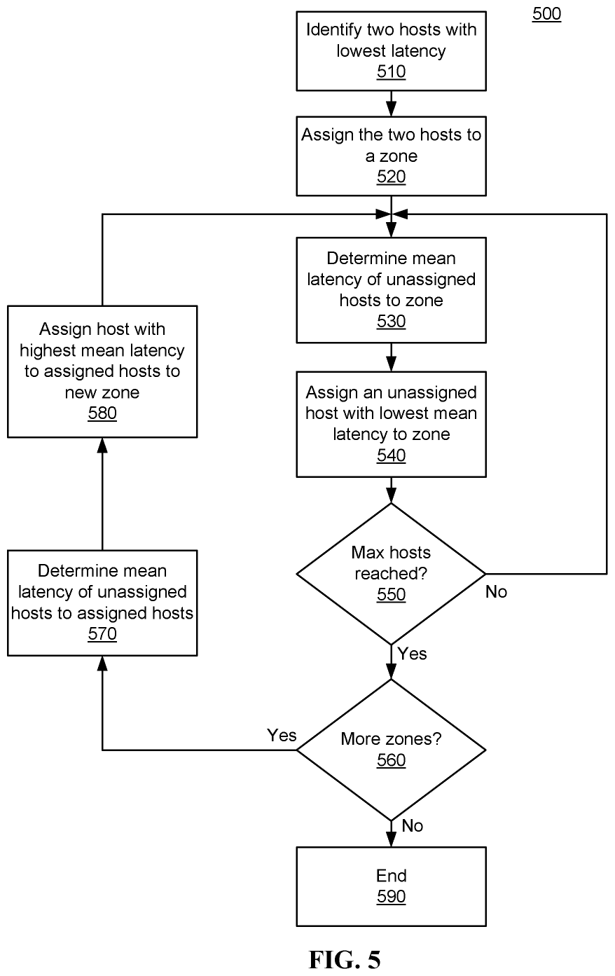

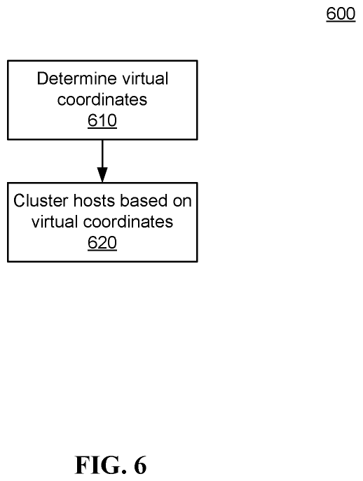

At operation 440, the hosts are clustered into zones based on latency. In some embodiments, the hosts that are clustered do not include hosts that were filtered in operation 420. The hosts may be clustered to have zones with low inter-host latency and higher inter-zone latency. The distributed computing provider, or a user in communication with the distributed computing provider, may set requirements for the number of zones and number of hosts per zones. In some embodiments, the hosts may be clustered using method 500 described in reference to FIG. 5. In some embodiments, the hosts may be clustered using method 600 described in reference to FIG. 6.

Referring now to FIG. 5, an example method 500 for assigning hosts to zones is depicted, according to embodiments. Method 500 may allow for even distribution of hosts across zones. Method 500 may be performed after determining latency metrics for each host with respect to each other host. Method 500 may be performed by a distributed computing system provider that manages a distributed computing environment.

At operation 510, the two hosts with the lowest latency between them are identified. At operation 520, the two hosts are assigned to a first zone.

At operation 530, a mean latency is determined for each of the unassigned hosts to the first zone. The mean latency from an unassigned host to the first zone is a mean of the latencies from the host to each host assigned to the first zone. The mean latency may be calculated in various ways. In some embodiments, the mean latency is calculated using a geometric mean.

At operation 540, the unassigned host with the lowest mean latency to the first zone is assigned to the first zone.

At operation 550, it is determined whether a maximum number of hosts has been assigned to the first zone. The number of hosts per zone may be set by the distributed computing provider or a user in communication with the distributed computing provider. If the maximum number of hosts has not been reached, the mean latency of unassigned hosts with respect to the first zone may be recalculated at operation 530 and the host with the lowest mean latency to the first zone may be assigned to the first zone.

If, at operation 550, the maximum number of hosts has been reached, it is determined whether there are more zones to assign hosts, at operation 560. The number of zones may be set by the distributed computing provider or a user in communication with the distributed computing provider.

If there are more zones to assign hosts, a mean latency of each unassigned host to the hosts that have been assigned is determined at operation 570. As discussed above with reference to operation 530, the mean latency may be calculated in various ways. If hosts have been assigned to multiple zones already, the mean latency may be calculated with respect to assigned hosts in multiple zones.

At operation 580, the unassigned host with the highest mean latency to assigned hosts is assigned to a new zone. Operation 530, operation 540, and operation 550 are then performed with respect to the new zone.

At operation 560, if there are no more zones to assign, or no more hosts to assign, method 500 ends at operation 590.

Referring now to FIG. 6, a flow diagram of a second example method 600 for assigning hosts to zones is depicted, according to embodiments. Method 600 may allow for zones that are optimized for latency, while not necessarily being balanced. Method 600 may be performed after determining latency metrics for each host with respect to each other host. Method 600 may be performed by a distributed computing system provider that manages a distributed computing environment.

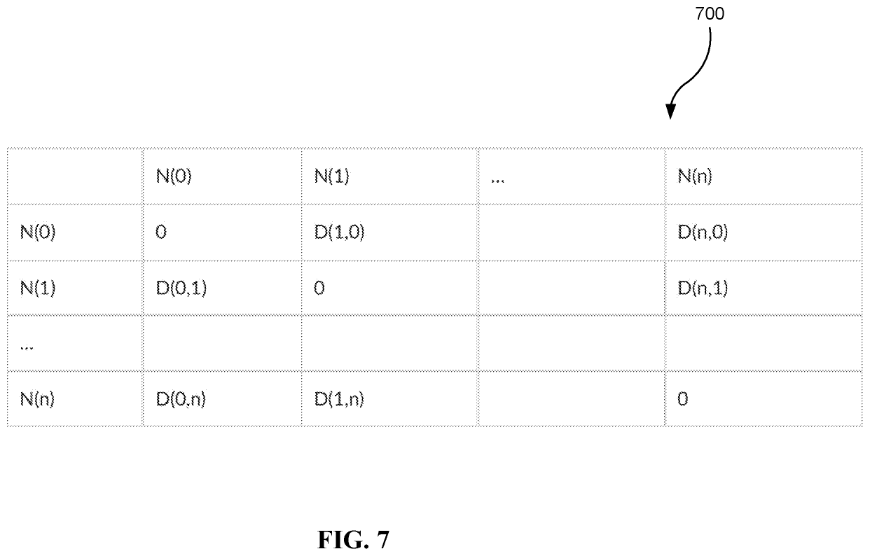

At operation 610, virtual coordinates may be determined for each host based on the determined latency metrics. In some embodiments, a distance matrix may be generated using the determined latency metrics. An example distance matrix 700 is depicted in FIG. 7. As depicted in FIG. 7, N(x) is a host where x is in the range 0 to n for n nodes. D(x,y) is the distance from host x to host y using the latency metric. The distance matrix may be converted into virtual coordinates for each host using an algorithm. Any suitable algorithm for converting the distance matrix into virtual coordinates may be used.

At operation 620, the hosts may be clustered based on the virtual coordinates using a clustering algorithm. Any suitable method of clustering may be used. In some embodiments, a kd tree may be generated based on the virtual coordinates using k-means clustering, limited to c centers, where c is the requested number of zones. Each of the clusters may be assigned to a different zone.

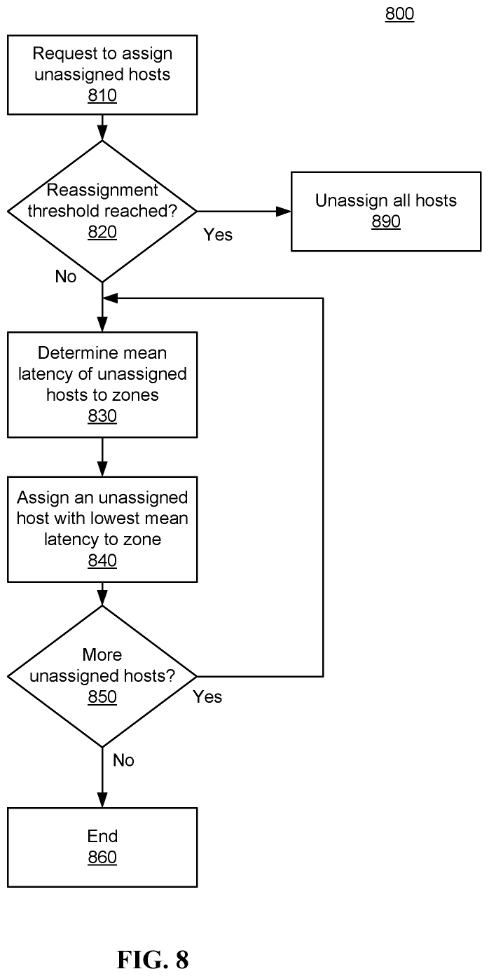

Referring now to FIG. 8, a flow diagram of an example method 800 for assigning additional hosts to zones when hosts have been previously assigned to zones is depicted, according to embodiments. Method 800 may be performed by a distributed computing system provider that manages a distributed computing environment.

At operation 810, a request is received to assign additional unassigned hosts. The request may come from a user system (e.g., user system 310) in communication with the distributed computing system provider. The additional hosts may be hosts that were recently attached to the distributed computing environment. In some embodiments, the request may be implicit in the attaching of new hosts to the distributed computing environment.

At operation 820, it is determined whether a reassignment threshold has been reached. A reassignment threshold may be set by user or by the distributed computing system provider. In some embodiments, a threshold may be based on the number of additional hosts relative to the number of existing hosts. For example, a threshold may be reached if the number of additional hosts exceeds a percentage of the number of existing hosts.

If the reassignment threshold is reached, the previously-assigned hosts are unassigned at operation 890. At this point, the hosts may be assigned to zones as discussed previously. For example, the hosts may be assigned according to method 400, method 500, and/or method 600 as described herein. In some embodiments, instead of reaching a reassignment threshold, a user may simply request that the previously-assigned hosts be unassigned, and the hosts be reassigned to zones.

If the reassignment threshold has not been reached, a mean latency may be determined for each of the unassigned hosts to each of the existing zones at operation 830.

At operation 840, the unassigned host with the lowest mean latency to a zone is assigned to that zone.

At operation 850, it is determined whether there are more hosts to assign to zones. If there are more hosts to assign, operation 830 and operation 840 may be repeated. If there are not more hosts to assign, method 800 may end at operation 860.

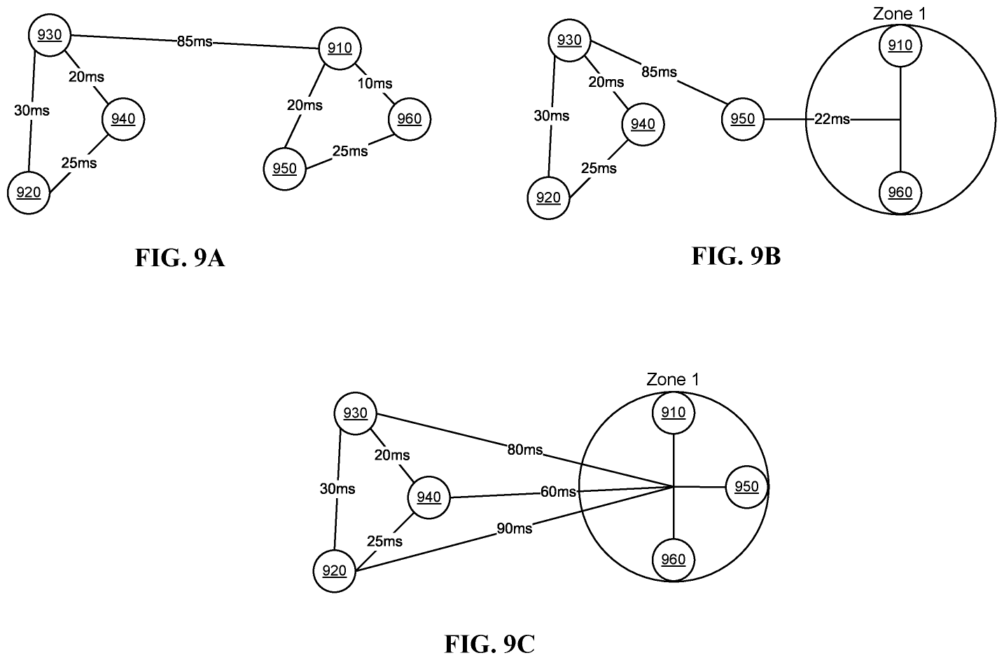

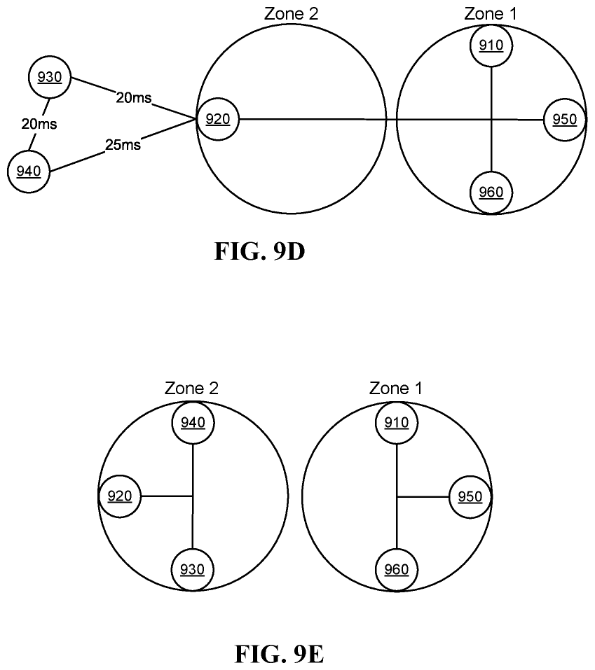

Referring now to FIGS. 9A-9E, an illustrative diagram of an example assignment of hosts to zones is depicted, according to embodiments. FIGS. 9A-9E depict the assignment of host 910, host 920, host 930, host 940, host 950, and host 960 into 2 zones with 3 hosts per zone. The assignments depicted in FIGS. 9A-9E may be consistent with method 500 described in reference to FIG. 5. While FIGS. 9A-9E depict hosts being moved into zones, it is to be understood that movement is shown to assist in understanding embodiments of the present disclosure and the hosts are not physically moved.

Referring now to FIG. 9A, the hosts that are to be assigned to zones and the latency metric between hosts are depicted. For the purpose of clarity, not all latency metrics are shown in FIG. 9A, however it will be assumed that the latency metrics that are not shown would not impact the assignment of hosts as described herein.

Referring now to FIG. 9B, host 910 and host 960 are assigned to Zone 1 based on the latency metric between the two hosts (10 ms) being the lowest. As depicted, host 950 has a geometric mean latency of approximately 22 ms to Zone 1 (i.e., host 910 and host 920). While not depicted, the geometric mean latencies of the other hosts to Zone 1 may also be determined, but they are greater than 22 ms.

Referring now to FIG. 9C, host 950 is assigned to Zone 1 based on having the lowest geometric mean latency to Zone 1. As depicted, the geometric mean latencies are determined for each of the remaining unassigned hosts (host 920, host 930, host 940) to Zone 1 (i.e., host 910, host 920, and host 960). Since Zone 1 has reached its capacity for hosts, the remaining hosts will be assigned to a new zone.

Referring now to FIG. 9D, host 920 is assigned to Zone 2 based on having the highest geometric mean latency to Zone 1. The assignment of the remaining hosts (host 930 and host 940) may be assigned to Zone 1 based on geometric mean latency to Zone 2.

Referring now to FIG. 9E, the final assignments of hosts to zones is depicted. As shown, Zone 1 includes host 910, host 950, and host 960, and Zone 2 includes host 920, host 930, and host 940.

While FIGS. 9A-9E show the assignment of 6 hosts into 2 zones with 3 hosts per zone, any suitable number of hosts, zones, and hosts per zone may be assigned according to embodiments of the present disclosure.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method for assigning hosts to zones in a distributed computing environment, the method comprising:
determining a latency metric for each of a plurality of hosts with respect to each other of the plurality of hosts; and
clustering a first set of hosts, from the plurality of hosts, into zones based on the latency metrics.

2. The method of claim 1, further comprising:
filtering one or more hosts from the plurality of hosts based on the one or more hosts failing to meet one or more designated latency requirements, wherein the filtered one or more hosts are not in the first set of hosts that are clustered.

3. The method of claim 1, further comprising:
labeling one or more hosts in response to the one or more hosts exceeding one or more latency metric thresholds.

4. The method of claim 1, wherein clustering the set of hosts into zones comprises:
assigning, to a first zone, two hosts from the first set of hosts with lowest latency between them; and
assigning, to the first zone, an unassigned host from the set of hosts based on mean latency between the unassigned host and hosts assigned to the first zone.

5. The method of claim 4, further comprising:
repeating the assigning, to the first zone, an unassigned host from the set of hosts based on mean latency between the unassigned host and hosts assigned to the first zone until a predetermined number of hosts are assigned to the first zone.

6. The method of claim 1, wherein a second set of hosts of the plurality of hosts are assigned to a plurality of zones, wherein clustering the first set of hosts into zones comprises:
assigning an unassigned host from the first set of hosts to a first zone from the plurality of zones based on mean latency between the unassigned host and the first zone being a lowest mean latency among mean latencies between each unassigned host and each of the plurality of zones.

7. The method of claim 6, further comprising:
repeating the assigning an unassigned host until there are no more unassigned hosts.

8. The method of claim 6, further comprising:
in response to determining that the first zone has a maximum number of assigned hosts, assigning a second unassigned host to a different zone based on mean latency between the second unassigned host and the different zone having lowest mean latency among mean latencies between each unassigned host and each of the plurality of zones excluding the first zone.

9. The method of claim 1, wherein the clustering a first set of hosts comprises:
determining virtual coordinates for each of the first set of hosts based on the determined latency metrics; and
clustering the first set of hosts based on the virtual coordinates.

10. A system for assigning hosts to zones in a distributed computing environment, the system comprising:
one or more computer-readable storage media; and
one or more processors communicatively coupled to the one or more computer-readable storage media, the one or more processors configured to perform operations comprising:
determining a latency metric for each of a plurality of hosts with respect to each other of the plurality of hosts; and
clustering a first set of hosts, from the plurality of hosts, into zones based on the latency metrics.

11. The system of claim 10, wherein the operations further comprise:
filtering one or more hosts from the plurality of hosts based on the one or more hosts failing to meet one or more designated latency requirements, wherein the filtered one or more hosts are not in the first set of hosts that are clustered.

12. The system of claim 10, wherein the operations further comprise:
labeling one or more hosts in response to the one or more hosts exceeding one or more latency metric thresholds.

13. The system of claim 10, wherein clustering the set of hosts into zones comprises:
assigning, to a first zone, two hosts from the first set of hosts with lowest latency between them; and
assigning, to the first zone, an unassigned host from the set of hosts based on mean latency between the unassigned host and hosts assigned to the first zone.

14. The system of claim 13, wherein the operations further comprise:
repeating the assigning, to the first zone, an unassigned host from the set of hosts based on mean latency between the unassigned host and hosts assigned to the first zone until a predetermined number of hosts are assigned to the first zone.

15. The system of claim 10, wherein a second set of hosts of the plurality of hosts are assigned to a plurality of zones, wherein clustering the first set of hosts into zones comprises:
assigning an unassigned host from the first set of hosts to a first zone from the plurality of zones based on mean latency between the unassigned host and the first zone being a lowest mean latency among mean latencies between each unassigned host and each of the plurality of zones.

16. The method of claim 15, wherein the operations further comprise:
repeating the assigning an unassigned host until there are no more unassigned hosts.

17. The system of claim 15, wherein the operations further comprise:
in response to determining that the first zone has a maximum number of assigned hosts, assigning a second unassigned host to a different zone based on mean latency between the second unassigned host and the different zone having lowest mean latency among mean latencies between each unassigned host and each of the plurality of zones excluding the first zone.

18. The system of claim 10, wherein the clustering a first set of hosts comprises:
determining virtual coordinates for each of the first set of hosts based on the determined latency metrics; and
clustering the first set of hosts based on the virtual coordinates.

19. A computer program product for assigning hosts to zones in a distributed computing environment, the computer program product comprising one or more computer-readable storage media having program instructions embodied therewith, the program instructions executable by one or more processors to cause the one or more processors to perform operations comprising:
determining a latency metric for each of a plurality of hosts with respect to each other of the plurality of hosts; and
clustering a first set of hosts, from the plurality of hosts, into zones based on the latency metrics.

20. The computer program product of claim 19, wherein clustering the set of hosts into zones comprises:
assigning, to a first zone, two hosts from the first set of hosts with lowest latency between them; and
assigning, to the first zone, an unassigned host from the set of hosts based on mean latency between the unassigned host and hosts assigned to the first zone.
